(19) United States
(12) Patent Application Publication
(10) Pub. No.: US 2017/0045020 A1
(43) Pub. Date: Feb. 16, 2017

(54) System Containing Nanoparticles and Magnetizing Components Combined with an Ultrasonic Atomizer used for Saving Diesel in an Internal Combustion Engine

(71) Applicant: Awad Rasheed Suleiman Mansour, Chicago Ridge, IL (US)

(72) Inventor: Awad Rasheed Suleiman Mansour, Chicago Ridge, IL (US)

(21) Appl. No.: 14/826,881

(22) Filed: Aug. 14, 2015

(51) Int. Cl. F02M 27/04

(52) U.S. Cl. CPC F02M 27/045; F23C 2200/00; F02M 2027/047

(57) ABSTRACT

The present invention relates to a system comprising an ultrasonic atomizer and a magnetic component for efficient burning of a fluid fuel in a combustion chamber, said magnetizing component comprising a magnetizing material and nanoparticles comprising oxides of cobalt, zinc, aluminum and magnesium. In preferred embodiments, said magnetizing material comprises Neodymium-Iron-Boron (NdFeB) magnet and said nanoparticles comprise Co₃O₄, ZnO, Al₂O₃ and MgO.

### TECHNICAL FIELD OF THE INVENTION

The present invention relates to a system comprising magnetic ultrasonic components for increasing efficiency of a combustion chamber operated with liquid diesel fuel, and more particularly the invention pertains to novel system comprising ultrasonic components along with magnetizing materials and nanosized particles as catalyst for conditioning the diesel fuel used in an internal combustion engine.

### BACKGROUND OF THE INVENTION

It is known that burning efficiency of the combustion chambers such as internal combustion engines is in very low level such that the combustion is carried out inefficiently and inappropriately with incomplete and falsified burning reactions producing unburned hydrocarbons (HC), carbon monoxide (CO) and oxides of nitrogen (NOₓ). Unburned HC and NOx react in the atmosphere to form photo-chemical smog. Smog is highly oxidizing in the environment and is the prime cause of eye and throat irritation, bad odor, plant damage, and decreased visibility. Oxides of Nitrogen are also toxic. CO impair blood capability to carry oxygen to the brain, resulting in slower reaction times and impaired judgement.

Generally a liquid diesel fuel used for an internal combustion engine is composed of a set of molecules. Each molecule includes a number of atoms, which is composed of a nucleus and electrons orbiting around their nucleus. The molecules have magnetic moments in themselves, and the rotating electrons cause magnetic phenomena. Thus, positive (+) and negative (−) electric charges exists in the fuel's molecules. For this reason, the fuel particles of the negative and positive electric charges are not splitted into more minute particles. Accordingly, the fuels are not actively interlocked with oxygen during combustion, thereby causing incomplete reactions. To improve the above, the fuels have been required to be decomposed and ionized. The term “ionization” implies that the fuel acquires a charge and molecules of like charge repel each other, which makes fuel dispersal more efficient.

There are plenty of attempts to modify the molecular arrangement and to ensure ionization of liquid fuels in internal combustion engines for improving efficiency of the burning process. One of the oldest and very popular one is placing a polarized material such as a magnet around the periphery of a fuel conduit before an engine or any combustion chamber so that an electrical field is created for modifying the fuel molecules. It is believed that groupings of hydrocarbons, when flowing through a magnetic field, change their orientations of magnetization in a direction opposite to that of the magnetic field. The molecules of hydrocarbon change their configuration. At the same time intermolecular force is considerably reduced or depressed by the effect of nanoparticles. These mechanisms are believed to help to disperse oil particles and to become finely divided into many submolecules with much higher surface area. In addition, hydrogen ions in fuel and oxygen ions in air or steam are magnetized to form magnetic domains which are believed to assist in atomizing fuel into finer particles.

As an example, U.S. Pat. No. 3,830,621, U.S. Pat. No. 4,188,296, U.S. Pat. No. 4,461,262, U.S. Pat. No. 4,572,145, U.S. Pat. No. 5,331,807, U.S. Pat. No. 5,664,546 disclose magnetizing assemblies for the purposes set forth above which generally include a magnet, South pole of which is brought in close proximity with a fuel line so that the fuel molecules are reorganized for improving the burning efficiency. The magnetizing material is placed onto various components of a combustion system with different arrangements, however, the effect of these systems is mostly quite limited because the magnetic field as such is mostly insufficient for ionization and conditioning of the fuel molecules in a closed conduit system. It is known that density of an electrical field imposed to a flowing liquid fuel is affected by many parameters such as the power of the magnetizer, its distance to the fuel per se, and even the material and the thickness of the housing or conduit of the fuel.

U.S. Pat. No. 4,986,248 discloses acoustic atomizing nozzles with limited improvement in fuel consumption and exhaust gas emission.

Therefore, the present invention solves a long felt need in this area by elimination of the problems encountered in fuel saving arrangements, with a system comprising ultrasonic atomizing nozzles, magnetizing materials and nanosized particles according to the appended claims.

Unlike conventional atomizing nozzles that rely on pressure and high-velocity motion to shear a fluid into small drops, the ultrasonic atomizer of the current invention uses only ultrasonic acoustic vibrational energy to generate a gentle, low-velocity spray by which it is possible to shorten the starting time when external air temperature is low and to improve combustion performance and exhaust gases properties using a fuel difficult to ignite. Moreover ultrasonic acoustic waves activate the action of nano catalyst on continuous basis to improve the combustion process.

### SUMMARY OF THE INVENTION

The present invention provides a system having ultrasonic atomizers and magnetic components in combination, for efficient burning of a fluid diesel fuel in a combustion chamber. Said magnetic components comprise a magnetizing material and nanoparticles comprising oxides of cobalt, zinc, aluminum and magnesium. In preferred embodiments, said magnetizing material comprises a magnet, and more particularly a Neodymium-Iron-Boron (NdFeB) magnet, and the said nanoparticles comprise Co₃O₄, ZnO, Al₂O₃ and MgO with particle sizes less than 500 nm, more preferably less than 100 nm.

Ultrasonic nozzles are known in the art as disclosed, for instance in U.S. Pat. No. 4,986,248, which is hereby incorporated with reference.

In the current invention, an ultrasonic atomizer is combined with the magnetic components comprising nanoparticles. In preferred embodiments, said nanoparticles can be placed into a tablet form that can be brought into physical contact with the fuel in a fuel supply system of the combustion chamber. In these embodiments the magnetizing material can be provided as a shell in the periphery of said tablet. The South pole of the magnet is arranged in close proximity to the nanoparticles while the North pole is spaced apart therefrom. In another embodiment, the magnetic component according to present invention is in the form of a fuel filter whereby the said nanoparticles are arranged in fuel passage ways to provide a direct contact with said diesel fuel.

The magnetizing material as defined herein can be provided in physical contact with the nanoparticles. The magnetic component according to the present invention can be placed onto a fuel supply line of the combustion chamber such that the nanoparticles are brought into physical contact with the fuel. The combustion chamber is preferably an internal combustion engine and the invention is found to have a particular effect if said fuel is diesel.

In the ultrasonic atomizers according to the present invention, an ultrasonic power supply is provided to produce mechanical vibrations at a certain frequency, i.e. 50/60 Hz. In principle, the electrical energy is transmitted to the piezo electric transducer within the converter, where it is changed to mechanical vibrations. The ultrasonic vibrations are intensified with a probe and focused at a tip thereof where the atomization takes place. The liquid diesel fuel travels through the probe and spreads out as a thin film on the atomizing surface. The oscillating tip disintegrates the liquid fuel into micro-droplets, and ejects them to form a gentle, low velocity spray.

### DETAILED DESCRIPTION OF THE INVENTION

Technical problem to be solved by the present invention is to find a fast assistant, which will accelerate ignition process, improve hydrocarbon combustion and prevent detonation and burning coke, in order for the engine produces maximum efficiency, and reduces fuel consumption and exhaust emissions.

These objects are achieved through a combined system comprising an ultrasonic atomizer, a magnetic material and energetic nanoparticles which are found to be producing a very effective synergistic outcome if they are used together to modify a liquid fuel before usage in a combustion chamber. The system mentioned above is aimed to be used in any combustion chamber like internal combustion engines utilizing of liquid fuels. It is however noted that best results were obtained in diesel fuel engines. The system can be placed on any component in a fuel supplying assembly such as the conduits, fuel pumps, filters and fuel injectors in a place before/after mixing chambers such as fuel injectors or carburetors.

The magnetic material according to the present invention comprises Neodymium Iron Boron (NdFeB) which is also known as a neodymium magnet in the market. As every magnet known in the state of the art, this magnetizing material shall be possessing polarized features having a South and North pole. In the context of the present invention, it is aimed to place the South pole in a close proximity of the liquid fuel in a fuel supply line. The magnetic material is preferably selected to have a magnetic field strength higher than 11,000 Gauss.

Energetic nanoparticles according to the present invention are provided as a mixture of the elements, i.e. oxides of the elements comprising Cobalt, Zinc, Aluminum and Magnesium. In the context of the present invention, the term nanoparticle refers to small particles having a particle size less than 500 nm and more particularly less than 100 nm. The proportion of each oxide in the mixture can be any value and even trace amounts produce the desired effect. Nevertheless, proportions of each oxide substantially equal to the others would be preferable. Such proportions can be arranged depending on the fuel type or costs of the oxides independently.

The inventor of the current invention unexpectedly found that the energetic nanoparticles as defined herein above behave as a catalyst if they are used in combination with magnetizing material as described herein. The catalyzing effect of the nanoparticles greatly enhances ionization of the fuel molecules and reorganization thereof especially in a flowing fuel system by virtue of the passivated oxide layers characterized by a high rate of energy release. In particular, energetic nanoparticles offer a high volumetric heat of oxidation, enabling transportation of more energy per given fuel volume. When mixed in a fuel or a composite, they generally exhibit faster ignition time scales due to the dramatic increase in the surface-to-volume ratio, and can ignite below the bulk melting point of the metal due to rapid temperature gradients through their thin oxide layers. It is thought that this system easily ionizes and separates the fuel into smaller groups, but the ultrasonic atomizer entends the effect of magnetic modification through the way of the fuel flow and prevents the fuel molecules to be reorganized and be reassembled together after the magnetic and catalytic effect of the magnetic components. Therefore, nano-sized energetic particles offer the potential of controlled burning rates, increased combustion efficiencies, and reduced exhaustion gases by virtue of the magnet which is further improved with an ultrasonic atomizer.

Therefore, the magnetic components comprising a magnetizing material and the nanoparticles according to the present invention are arranged such that the said nanoparticles are arranged in a device in fluid communication with the liquid fuel. Due to this direct contact with the fluid, the magnetizing power and the electrical field created by the magnetizing material is directly transferred to the fuel molecules without the limitations of the systems in prior art. Therefore, the magnetic component according to the instant invention can be embodied as a fuel filter whereby the nanoparticles are arranged in fluid communication with the liquid fuel and the magnetizing material is provided in a shell. Alternatively, the magnetic component can be arranged as a device wherein nanoparticles are provided in a tablet and the magnetizing material can be provided in a shell. In this arrangement, said tablets are arranged in a replaceable manner.

Irrespective of the specific form of the magnetic components, these are arranged in combination with the ultrasonic atomizers to form the system according to the present invention, and said ultrasonic atomizers comprise a power supply, an oscillating member to produce a fuel spray that is magnetized and modified with magnetic and catalytic effect of the magnetic components. Said atomizer may optionally comprise a nozzle for acceleration of the fluid flow. Said magnetic components comprising a magnet and nanoparticles according to this invention can be placed in a fuel line before or after the ultrasonic atomizer. Therefore, this system overall conditions the fuel by mechanical, magnetic and catalytic ways.

The nanoparticles according to this invention do not dissolve in hydrocarbon fuel, and therefore they offer a long term run in a particular device such as a filter as mentioned above. In particular embodiments of the present invention, there is no need to provide said nanoparticles in physical contact with the magnetizing material because the said nanoparticles may well transfer the electrical field to the liquid fuel and catalize the same. Nevertheless, it would be preferable to provide this physical contact in an integrated device for obtaining the electrical field with the desired strength.

In preferred embodiments of the present invention, the oxides of cobalt, zinc, aluminum and magnesium comprised in the nanoparticles as described herein are cobalt oxide (Co₃O₄), zinc oxide (ZnO), alumina (Al₂O₃) and magnesia (MgO), respectively.

By virtue of the enhanced magnetic field transfer in molecular level, the fuel is dispersed into more tiny particles and becomes less viscous. The resultant conditioned fuel/air mixture as magnetized herein burns more completely, producing higher engine output, better fuel economy, more power and most importantly reduces the amount of hydrocarbons, especially carbon monoxide and oxides of nitrogen in the exhaust gas. Another benefit of these components is that magnetically charged fuel molecules with opposite polarities dissolve carbon build-up in carburettor jets, fuel injectors, and combustion chambers, and they help to clean up the engine and maintain its clean condition.

The inventor of the present invention has surprisingly found that the combined system according to the instant invention can produce the effects of making combustion almost complete (with unburned hydrocarbon less than 20 ppm), lowering gas consumption up to 60%, burning out carbon deposit, reducing gas pollution especially carbon monoxide (CC)) which is reduced down to 0.0%, and increasing engine performance drastically.

### EXAMPLES

A filter arrangement comprising an ultrasonic atomizer, magnetizing material (NdFeB) as a shell and the nanoparticles (a mix of oxides of Co, Zn, Al, and Mg) having a particle size arrangement less than 100 nm contained in a tablet is placed into a fuel conduit supplying diesel fuel to the fuel injectors in vehicles of different brands.

The vehicles are tested in identical conditions with constant speed in the same route. Following are the fuel saving results of each vehicle tested in the procedure:

| | Fuel saving |
|---|---|
| Automobile | (%) |
| 2000 Hyundai H100 (2700 cc Turbo Engine) | 75 |
| 2004 Hyundai Grace (3000 cc Turbo Engine) | 65 |
| 2003 Toyota Coaster Bus (4700 cc Engine) | 60 |
| 2001 Mercedes (1.8 liter Engine) | 75 |
| 2007 Peugeot Boxer, (3000 cc Engine) | 80 |

### Emission

2004 Hyundai Grace (3.0 liter turbo engine) mentioned above was tested by measuring the exhaust gases. The results were as follows:

Carbon Monoxide (CO): 0.0%

HC (Hydrocarbon): 38 ppm

CO₂: 14.6%

O₂: 0.06%

1. A system for efficient burning of a fluid fuel in a combustion chamber comprising an ultrasonic atomizer for producing mechanical vibrations, a magnetizing material and nanoparticles comprising oxides of cobalt, zinc, aluminum and magnesium, said magnetizing material producing a magnetic field on said nanoparticles whereas said nanoparticles being arranged in contact with the fuel.

2. The system according to claim 1 wherein said ultrasonic atomizer comprises means for oscillation actuated by a power supply, and said atomizer is arranged on the fuel line of the combustion chamber in close proximity to the magnetizing material and nanoparticles.

3. The system according to claim 1 wherein said magnetizing material comprises a Neodymium-Iron-Boron (NdFeB) magnet.

4. The system according to claim 1 wherein the nanoparticles comprise Co₃O₄, ZnO, Al₂O₃ and MgO.

5. The system according to claim 1 wherein said nanoparticles have particle sizes less than 100 nm.

6. The system according to claim 1 wherein said nanoparticles are placed into a tablet that can be brought into physical contact with the fuel in a fuel supply system.

7. The system according to claim 6 wherein the magnetizing material is provided as a shell in the periphery of said tablet.

8. The system according to claim 6 wherein south pole of the magnet is arranged in close proximity to the nanoparticles while the north pole is spaced apart therefrom.

9. The system according to claim 1 wherein said nanoparticles and magnetizing material are placed into a fuel filter whereby the said nanoparticles are arranged in fuel passageways to provide a direct contact with said fuel.

10. The system according to claim 1 wherein the magnetizing material is provided in physical contact with the nanoparticles.

11. The system according to claim 1 wherein the combustion chamber is a diesel engine.

12. A method for improving burning in a combustion chamber comprising placing of the system according to claim 1 onto a fuel supply line of the combustion chamber such that the nanoparticles are brought into physical contact with the fuel.

13. A method according to claim 12 wherein the combustion chamber is a diesel engine.

14. A method according to claim 13 wherein the nanoparticles are arranged within a tablet or fuel filter and the magnetizing material is provided as a shell around the periphery of said tablet or filter.

15. A method according to claim 14 wherein said magnetizing material comprises Neodymium-Iron-Boron (NdFeB) magnet and said nanoparticles comprise Co₃O₄, ZnO, Al₂O₃ and MgO.
